(19) United States
(12) Patent Application Publication
(10) Pub. No.: US 2017/0169720 A1
(43) Pub. Date: Jun. 15, 2017

(54) Manicure Teaching Kit

(71) Applicants: Linda McCarthy, Lahaina, HI (US); Kevin K. Brooks, Lahaina, HI (US)

(72) Inventors: Linda McCarthy, Lahaina, HI (US); Kevin K. Brooks, Lahaina, HI (US)

(21) Appl. No.: 14/963,507

(22) Filed: Dec. 9, 2015

(51) Int. Cl. G09B 19/00

(52) U.S. Cl. CPC G09B 19/00

(57) ABSTRACT

A manicure teaching kit includes a panel that may be positioned on a support surface. A plurality of bottles is provided and each of the bottles contains a liquid pigment. A pillow is selectively positioned on the panel. A pair of prosthetics is provided. Each of the prosthetics is selectively positioned on the pillow such that each of the prosthetics facilitates a user to practice manicuring. A pair of brushes is provided. Each of the brushes is insertable into a selected one of the bottles such that each of the brushes is soaked with the liquid pigment. Each of the brushes is manipulated thereby facilitating the liquid pigment to be applied to each of the prosthetics.

### BACKGROUND OF THE DISCLOSURE

### Field of the Disclosure

The disclosure relates to teaching devices and more particularly pertains to a new teaching device for teaching the art of manicuring.

### SUMMARY OF THE DISCLOSURE

An embodiment of the disclosure meets the needs presented above by generally comprising a panel that may be positioned on a support surface. A plurality of bottles is provided and each of the bottles contains a liquid pigment. A pillow is selectively positioned on the panel. A pair of prosthetics is provided. Each of the prosthetics is selectively positioned on the pillow such that each of the prosthetics facilitates a user to practice manicuring. A pair of brushes is provided. Each of the brushes is insertable into a selected one of the bottles such that each of the brushes is soaked with the liquid pigment. Each of the brushes is manipulated thereby facilitating the liquid pigment to be applied to each of the prosthetics.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a manicure teaching kit according to an embodiment of the disclosure.

FIG. 2 is a left side view of an embodiment of the disclosure.

FIG. 3 is a perspective view of an embodiment of the disclosure.

FIG. 4 is a back view of an embodiment of the disclosure.

FIG. 5 is a perspective in-use view of an embodiment of the disclosure.

### DESCRIPTION OF THE PREFERRED EMBODIMENT

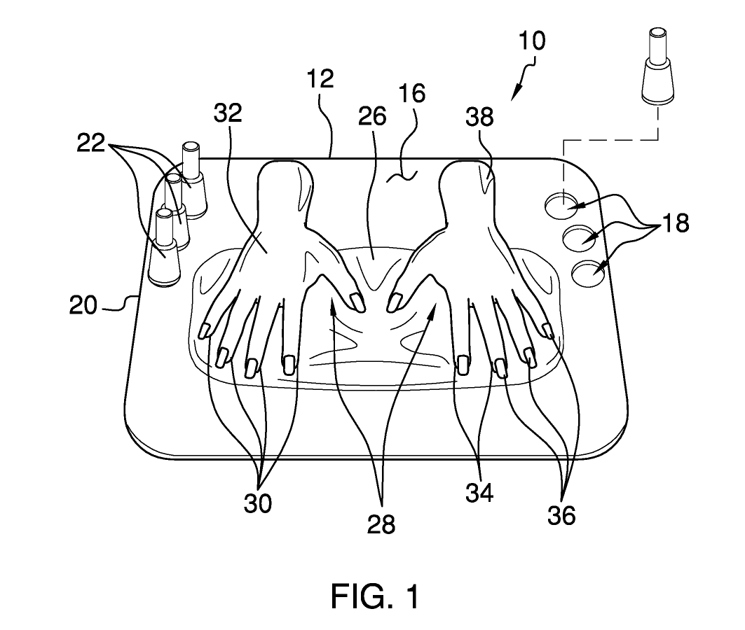

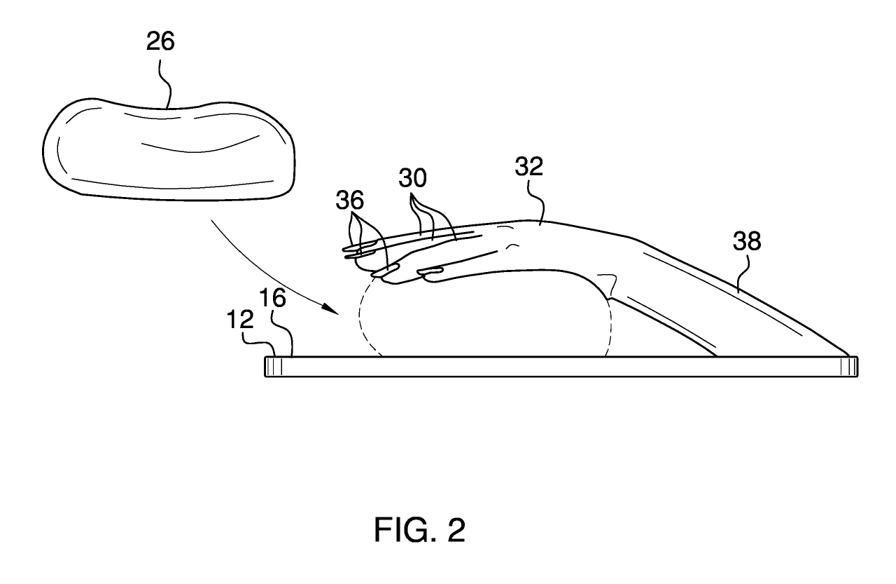

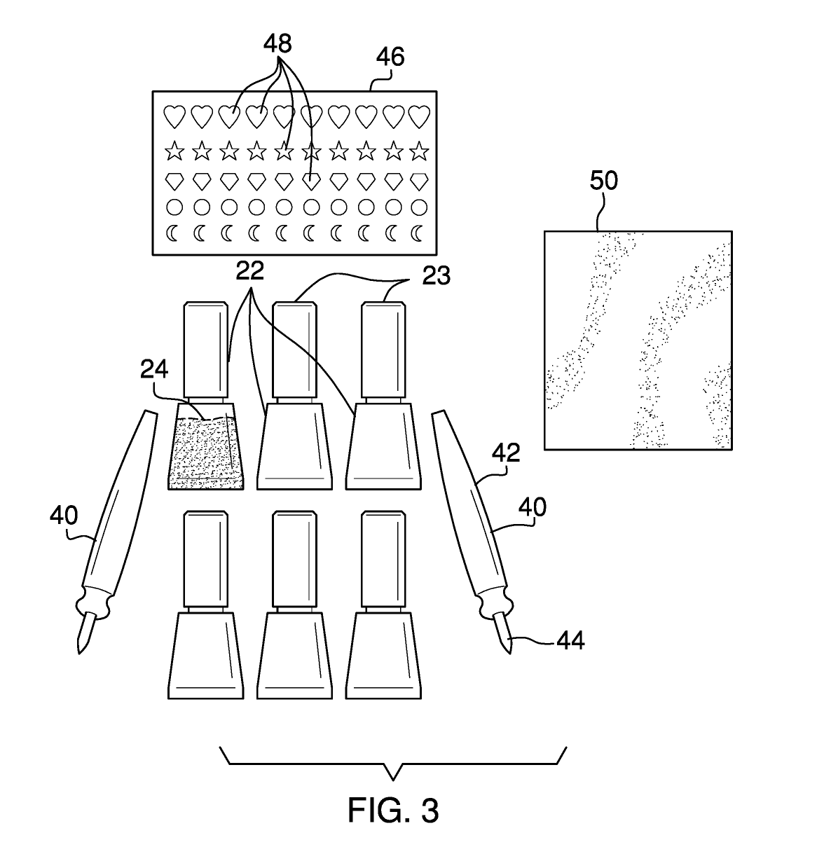

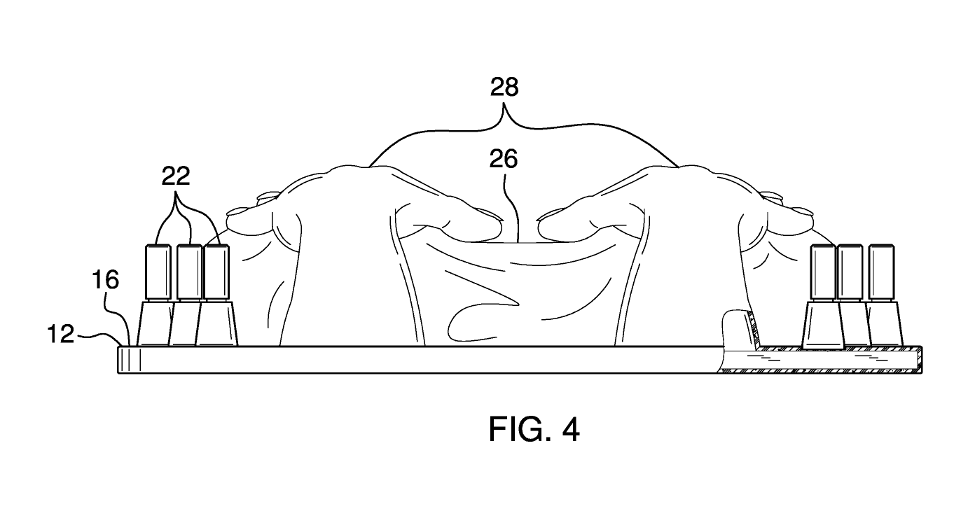

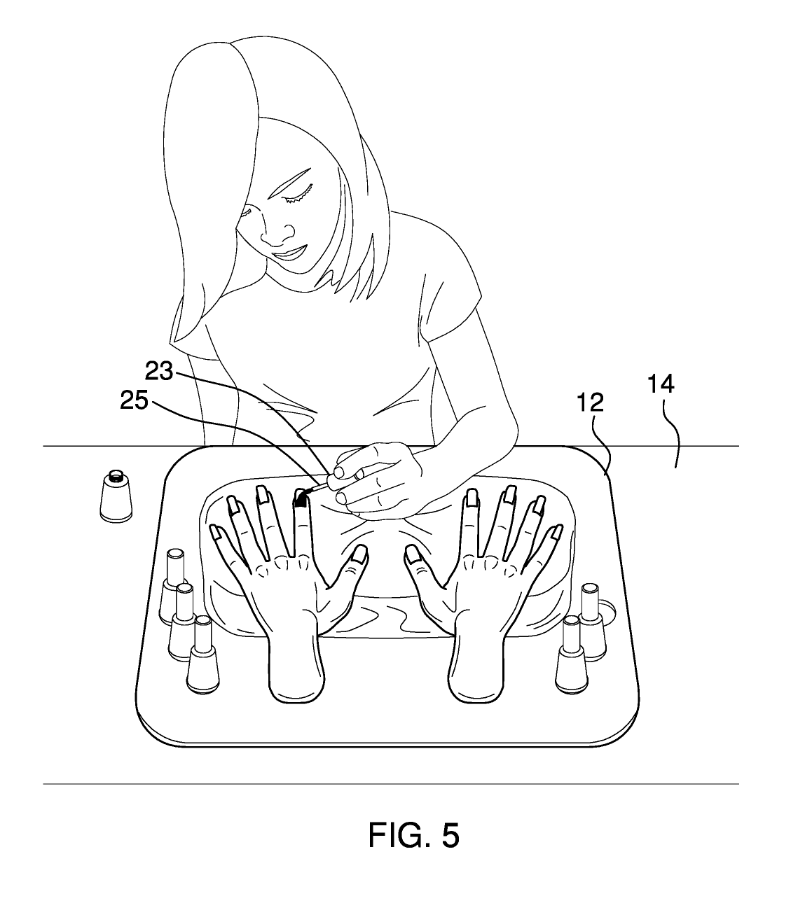

With reference now to the drawings, and in particular to FIGS. 1 through 5 thereof, a new teaching device embodying the principles and concepts of an embodiment of the disclosure and generally designated by the reference numeral 10 will be described.

As best illustrated in FIGS. 1 through 5, the manicure teaching kit 10 generally comprises a panel 12 that may be positioned on a support surface 14. The panel 12 has a top surface 16 and the top surface 16 has a plurality of wells 18 extending downwardly therein. The wells 18 may be positioned adjacent to a peripheral edge 20 of the panel 12. The support surface 14 may comprise a table or the like.

A plurality of bottles 22 is provided and each of the bottles 22 contains a liquid pigment 24. Selected ones of the bottles 22 are positionable within a selected one of the wells 18. The liquid pigment 24 in each of the bottles 22 may have a distinct color with respect to each other. Each of the bottles 22 may comprise a nail polish bottle or the like.

Each of the bottles 22 has a lid 23 and an applicator 25 is coupled to the lid. The applicator 25 may comprise a nail polish brush or the like. The liquid pigment 24 may comprise a water based, non toxic and washable paint or the like. A pillow 26 is provided and the pillow 26 may be selectively positioned on the top surface 16 of the panel 12. The pillow may be an integral part of the panel 12.

A pair of prosthetics 28 is provided. Each of the prosthetics 28 is selectively positioned on the pillow 26 when the pillow 26 is positioned on the panel 12. Thus, each of the prosthetics 28 facilitates a user to practice manicuring. Each of the prosthetics 28 comprises a plurality of digits 30 and a hand 32. Each of the digits 30 extends away from the hand 32. Each of the digits 30 has a distal end 34 with respect to the hand 32.

Each of the prosthetics 28 further includes a plurality of nails 36. Each of nails 36 is coupled to an associated one of the digits 30. Each of the nails 36 is positioned adjacent to the distal end 34 corresponding to the associated digit 30. A wrist 38 extends away from the hand 32. The wrist 38 angles downwardly from the hand 32. Thus, the wrist 38 extends between the top surface 16 of the panel 12 and the pillow 26 when the prosthetics 28 are positioned on the pillow 26. Each of the prosthetics 28 may be an integral part of the panel 12 and each of the prosthetics 28 may be removable from the panel 12.

A pair of brushes 40 is provided. Each of the brushes 40 includes a handle 42 and a tip 44. The tip 44 of each of the brushes 40 is insertable into a selected one of the bottles 22 such that the tip 44 is soaked with the liquid pigment 24. The handle 42 of each of the brushes 40 may be manipulated thereby facilitating the tip 44 to apply the liquid pigment 24 to each of the nails 36.

A sticker panel 46 is provided. A plurality of decals 48 is removably positioned on the sticker panel 46. Selected ones of the decals 48 may be positioned on the prosthetics 28 for decorative purposes. A sponge 50 is provided and the sponge 50 is used to wash the liquid pigment 24 from the nails 36.

In use, each of the prosthetics 28 is positioned on the pillow 26. Selected ones of the bottles 22 are positioned within selected ones of the wells 18. The applicator 25 corresponding to a selected bottle is manipulated to apply the liquid pigment 24 in a uniform fashion on each of the nails 36. The brushes 40 are dipped in the liquid pigment 24. The brushes 40 are manipulated to paint fine details the nails 36 when the nails 36 have a uniform coat of the liquid pigment 24. Selected decals 48 are applied to the nails 36 at any time. Thus, the prosthetics 28 facilitate the user to practice painting nails 36 and manicuring. The liquid pigment 24 is washed from the nails 36 after the nails 36 are painted.

With respect to the above description then, it is to be realized that the optimum dimensional relationships for the parts of an embodiment enabled by the disclosure, to include variations in size, materials, shape, form, function and manner of operation, kit and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A manicure teaching kit comprising:
a panel being configured to be positioned on a support surface;
a plurality of bottles, each of said bottles containing a liquid pigment;
a pillow being selectively positioned on said panel;
a pair of prosthetics, each of said prosthetics being selectively positioned on said pillow wherein each of said prosthetics is configured to facilitate a user to practice manicuring; and
a pair of brushes, each of said brushes being insertable into a selected one of said bottles such that each of said brushes is soaked with the liquid pigment, each of said brushes being configured to be manipulated thereby facilitating said liquid pigment to be applied to each of said prosthetics.

2. The kit according to claim 1, wherein:
said panel has a top surface, said top surface having a plurality of wells extending downwardly therein; and
selected ones of said bottles being positionable within a selected one of said wells.

3. The kit according to claim 1, wherein each of said prosthetics comprises a plurality of digits and a hand, each of said digits extending away from said hand, each of said digits having a distal end with respect to said hand.

4. The kit according to claim 3, further comprising a plurality of nails, each of nails being coupled to an associated one of said digits, each of said nails being positioned adjacent to said distal end corresponding to said associated digit.

5. The kit according to claim 3, further comprising a wrist extending away from said hand, said wrist angling downwardly from said hand such that said wrist extends between said top surface of said panel and said pillow when said prosthetics are positioned on said pillow, said wrist having a distal end with respect to said hand.

6. A manicure teaching kit comprising:
a panel being configured to be positioned on a support surface, said panel having a top surface, said top surface having a plurality of wells extending downwardly therein;
a plurality of bottles, each of said bottles containing a liquid pigment, selected ones of said bottles being positionable within a selected one of said wells;
a pillow being selectively positioned on said top surface of said panel;
a pair of prosthetics, each of said prosthetics being selectively positioned on said pillow wherein each of said prosthetics is configured to facilitate a user to practice manicuring, each of said prosthetics comprising:
a plurality of digits and a hand, each of said digits extending away from said hand, each of said digits having a distal end with respect to said hand;
a plurality of nails, each of nails being coupled to an associated one of said digits, each of said nails being positioned adjacent to said distal end corresponding to said associated digit;
a wrist extending away from said hand, said wrist angling downwardly from said hand such that said wrist extends between said top surface of said panel and said pillow when said prosthetics are positioned on said pillow; and
a pair of brushes, each of said brushes being insertable into a selected one of said bottles such that each of said brushes is soaked with the liquid pigment, each of said brushes being configured to be manipulated thereby facilitating said liquid pigment to be applied to each of said nails.
